(19) United States
(12) Patent Application Publication
(10) Pub. No.: US 2011/0062866 A1
(43) Pub. Date: Mar. 17, 2011

(54) PLASMA DISPLAY PANEL

(75) Inventors: Takeshi TAMAKOSHI, Kokubunji (JP); Mitsuharu IKEDA, Mito (JP); Keizo SUZUKI, Kodaira (JP); Shirun HO, Higashimatsuyama (JP); Yoshiro MIKAMI, Hitachiota (JP)

(73) Assignee: HITACHI CONSUMER ELECTRONICS CO., LTD., Tokyo (JP)

(21) Appl. No.: 12/850,701

(22) Filed: Aug. 5, 2010

(30) Foreign Application Priority Data
Sep. 15, 2009 (JP) 2009-213334

(51) Int. Cl. H01J 17/49

(52) U.S. Cl. 313/587

(57) ABSTRACT

A protective layer has, on its back side, an electron emissive layer formed of magnesium oxide crystals. Based on a front view of discharge cells C, there are defined intersection regions (first regions) where display electrode pairs (each including a sustain electrode X and a scan electrode Y) and address electrodes Z intersect and a remaining region (a second region) E1 excluding the intersection regions. The surface density of the magnesium oxide crystals forming the electron emissive layer over the intersection regions (the first regions) is equal to or lower than half the surface density of the magnesium oxide crystals forming the electron emissive layer over the remaining region (the second region) E1 excluding the intersection regions.

### CLAIM OF PRIORITY

The present application claims priority from Japanese patent application JP 2009-213334 filed on Sep. 15, 2009, the content of which is hereby incorporated by reference into this application.

### FIELD OF THE INVENTION

The present invention relates to a technique effectively applicable to plasma display panels (hereinafter also referred to as “PDPs”) used in display devices such TVs.

### BACKGROUND OF THE INVENTION

A plasma display panel (PDP) is a matrix type display device in which vacuum ultraviolet rays generated by gas discharge excite phosphors causing them to emit light. Plasma display panel TVs (PDP-TVs) are plasma display devices using AC surface discharge type PDPs, i.e. the type of PDPs most widely put in practical use, and have been building up their position in the market of large flat-screen TVs while competition between them and other types of display devices including liquid crystal display devices has been heating up.

Generally used methods of gray level representation for PDPs include an Address Display-Period Separation (ADS) method. In the ADS method, each TV field ( 1/60 s) used to display an image is divided into plural subfields according to predetermined luminance ratios, and the subfields are selectively made to emit light depending on the image to be displayed so as to represent different gray levels based on luminance differences between them. Each subfield has a reset period, an address period, and a sustain period. During the reset period, to make the wall voltage approximately the same in all discharge cells arranged in a matrix array, a voltage not lower than the discharge starting voltage is applied between each display electrode pair and a reset discharge is carried out in every discharge cell. During the address period, only in the discharge cells to be lit out of all the discharge cells, an address discharge is carried out to generate an appropriate amount of wall charge. In the sustain period, sustain discharge is carried out a number of times using the wall charge with the number determined according to the gray level value of display data.

Decreasing the power consumption by PDPs is an important object to be achieved to reduce the burden on the environment. For this reason, luminance efficiency improvement for PDPs has been under study. A known approach to improve the luminance efficiency of a PDP is to increase the proportion of Xe gas contained in the discharge gas the main component of which is Ne. Increasing the partial pressure of Xe gas, however, possibly causes such problems as raising the discharge voltage to increase the impact of ion bombardment on the protective layer and eventually shorten the life of the PDP and increasing the address discharge delay.

In recent years, to cope with scheduled starting of high-definition digital broadcasting on a full-scale basis, display devices have been made capable of high-definition (HD) display. To make a display device capable of higher-definition display requires the number of scanning lines to be increased for the display device. This increases the time required for address operation performed to determine whether or not to light each cell of the display device. When the proportion of the address period among the three periods increases, the proportion of the sustain period that is important in realizing higher-luminance and higher-contrast display is decreased.

To prevent the time required for address operation from increasing, it is necessary to make the pulse width of the address discharge voltage (also referred to as the “address voltage”) smaller. Since, however, the time (address discharge delay) taken between when a voltage is applied and when discharge occurs varies, there can be cases where an address voltage with a small pulse width fails to cause discharge. In such cases, the cells do not correctly emit light and, as a result, image quality is degraded. Hence, to improve the PDP image quality, it is necessary to reduce the address discharge delay.

In JP-A-2006-114484, it is disclosed that the address discharge delay can be reduced by forming an electron emissive layer of magnesium oxide crystals over a protective layer. The magnesium oxide crystals are excited by a reset discharge carried out before an address discharge and are assumed to subsequently emit electrons little by little. It is considered that the electrons thus emitted become the seeds of discharge to facilitate occurrence of an address discharge so as to reduce the address discharge delay.

In JP-A-2008-282624, it is proposed that an electron emissive layer of magnesium oxide crystals be formed, on a side opposing a back substrate, to be within a bus electrode region as seen from a front. An electron emissive layer formed in such a region can not wholly transmit light emitted by phosphors, so that a reduction in luminance may be feared. Forming an electron emissive layer in such a region where light is not wholly transmitted is aimed at preventing a reduction in luminance.

### SUMMARY OF THE INVENTION

A PDP is a light emitting device making use of gas discharge. In a PDP, a protective layer covering a dielectric layer is always exposed to plasma generated when a sustain discharge takes place. To extend the life and increase the reliability of a PDP, it is important to enhance the sputtering resistance of the protective layer.

In JP-A-2008-282624 and JP-A-2006-114484, how forming an electron emissive layer over a protective layer will affect the sputtering resistance of the protective layer is not considered.

The present inventors fabricated a prototype PDP having a protective layer covered with an electron emissive layer and studied the sputtering resistance of the protective layer. The prototype high-definition panel had a strip-shaped pixel structure and strip-shaped transparent electrodes. The magnesium oxide crystals used to form an electron emissive layer had grain diameters of 0.5 μm to several μm. They were dispersed uniformly over the panel surface.

After being subjected to a life test for a prolonged time, the prototype PDP was disassembled and the surface profile of the protective layer was analyzed using analysis devices. As shown in the optical micrograph of FIG. 24, a protective layer covered with no electron emissive layer showed discharge craters in electrode regions and a darkish deposition around each electrode region. On the other hand, as shown in the optical micrograph of FIG. 25, a protective layer covered with an electron emissive layer formed by spraying magnesium oxide crystals showed, besides discharge craters, numerous redepositions caused by crystal growth around magnesium oxide crystals as nuclei.

The present inventors subsequently analyzed sections of a protective layer covered with an electron emissive layer. As the scanning electron microscope (SEM) image of FIG. 26 shows, an electrode region of a protective layer covered with no election emissive layer was dug flatly, whereas a protective layer covered with an electron emissive layer of magnesium oxide crystals had, as the SEM image of FIG. 27 shows, deeply dug spots, deeper than those observed on the protective layer covered with no electron emissive layer, in limited areas ranging about several μm around redepositions formed in discharge craters.

Thus, forming an electron emissive layer of magnesium oxide crystals over a protective layer, particularly, in a region near a discharge gap where field strength is high, results in reducing the sputtering resistance, i.e. resistance against ion bombardment at sustain discharge, of parts around redepositions of the protective layer.

An object of the present invention is to provide a technique for realizing a long-life PDP capable of quality image display.

The above and other objects and novel features of the present invention will become apparent from the following description and the accompanying drawings.

An embodiment of a representative one of the inventions disclosed in this application will be briefly described below.

The embodiment is a plasma display panel which includes: a front substrate and a back substrate opposing each other across a discharge space; plural display electrode pairs, each pair including a sustain electrode and a scan electrode which are arranged, on a back side of the front substrate, along a first direction to be spaced apart by a discharge gap having a predetermined width and which extend along a second direction perpendicular to the first direction; a dielectric layer covering the display electrode pairs; a protective layer covering the dielectric layer; plural address electrodes arranged on a display side of the back substrate and extending along the first direction; and plural discharge cells formed by the display electrode pairs and the address electrodes facing each other across the discharge space. In the plasma display panel: an electron emissive layer including magnesium oxide crystals is formed on a back side of the protective layer; there are defined plural intersection regions in which the display electrode pairs and the address electrodes intersect as seen in a front view of the discharge cells and a remaining region excluding the intersection regions; and the surface density of the magnesium oxide crystals included in the electron emissive layer in the intersection regions is equal to or lower than half the surface density of the magnesium oxide crystals included in the electron emissive layer in a whole or part of the remaining region.

The advantageous effect of an embodiment of a representative one of the inventions disclosed in this application will be briefly described below.

A long-life PDP capable of quality image display can be realized by inhibiting degradation of the sputtering resistance of a protective layer caused when an electron emissive layer of magnesium oxide crystals is made use of and by achieving a balance between reduction of the address discharge delay and improvement of the sputtering resistance of the protective layer.

### BRIEF DESCRIPTION OF THE DRAWINGS

FIG. 1 is a partial front view schematically showing a part of a PDP cell structure according to a first embodiment of the present invention;

FIG. 2 is an exploded perspective view schematically showing a part of the PDP cell structure according to the first embodiment of the present invention;

FIG. 3 is a partial sectional view taken along line I—I′ in FIG. 1;

FIG. 4 is a partial front view schematically showing a part of a PDP cell structure according to a first example of a second embodiment of the present invention;

FIG. 5 is a partial front view schematically showing a part of a PDP cell structure according to a second example of the second embodiment of the present invention;

FIG. 6 is a partial front view schematically showing a part of a PDP cell structure according to a third example of the second embodiment of the present invention;

FIG. 7 is a partial front view schematically showing a part of a PDP cell structure according to a fourth example of the second embodiment of the present invention;

FIG. 8 is a partial front view schematically showing a part of a PDP cell structure according to a fifth example of the second embodiment of the present invention;

FIG. 9 is a partial front view schematically showing a part of a PDP cell structure according to a sixth example of the second embodiment of the present invention;

FIG. 10 is a partial front view schematically showing a part of a PDP cell structure according to a first example of a third embodiment of the present invention;

FIG. 11 is a partial front view schematically showing a part of a PDP cell structure according to a second example of the third embodiment of the present invention;

FIG. 12 is a partial front view schematically showing a part of a PDP cell structure according to a third example of the third embodiment of the present invention;

FIG. 13 is a partial front view schematically showing a part of a PDP cell structure according to a fourth example of the third embodiment of the present invention;

FIG. 14 is a partial front view schematically showing a part of a PDP cell structure according to a fifth example of the third embodiment of the present invention;

FIG. 15 is a partial front view schematically showing a part of a PDP cell structure according to a sixth example of the third embodiment of the present invention;

FIG. 16 is a partial front view schematically showing a part of a PDP cell structure according to a seventh example of the third embodiment of the present invention;

FIG. 17 is a partial front view schematically showing a part of a PDP cell structure according to a first example of a fourth embodiment of the present invention;

FIG. 18 is a partial front view schematically showing a part of a PDP cell structure according to a second example of the fourth embodiment of the present invention;

FIG. 19 is a partial front view schematically showing a part of a PDP cell structure according to a third example of the fourth embodiment of the present invention;

FIG. 20 is a partial front view schematically showing a part of a PDP cell structure according to a fourth example of the fourth embodiment of the present invention;

FIG. 21 is a partial front view schematically showing a part of a PDP cell structure according to a fifth example of the fourth embodiment of the present invention;

FIG. 22 is a partial front view schematically showing a part of a PDP cell structure according to a sixth example of the fourth embodiment of the present invention;

FIG. 23 is a partial front view schematically showing a part of a PDP cell structure according to a seventh example of the fourth embodiment of the present invention;

FIG. 24 is an optical micrograph showing discharge craters formed on the surface of a protective layer covered with no electron emissive layer studied by the present inventors;

FIG. 25 is an optical micrograph showing discharge craters formed on the surface of a protective layer covered with an electron emissive layer studied by the present inventors;

FIG. 26 is a sectional SEM image of a protective layer covered with no electron emissive layer studied by the present inventors; and

FIG. 27 is a sectional SEM image of a protective layer covered with an electron emissive layer studied by the present inventors.

### DETAILED DESCRIPTION OF THE PREFERRED EMBODIMENTS

In the following, the description will be divided into two or more sections or will range over two or more embodiments as required for the sake of convenience. Unless otherwise expressed, such sections and embodiments are not mutually irrelevant. For example, among such sections and embodiments, one is a partial or total modification of another, or one elaborates or supplements another.

Also, numbers referred to in the following description of embodiments (for example, numbers representing counts, amounts, ranges, or other numeric values) are not defined values, that is, they may be smaller or larger unless otherwise expressed or except when they are apparently defined in principle. Furthermore, the constituent elements (including element steps) of the following embodiments are not necessarily indispensable unless otherwise expressed or except when they are apparently indispensable in principle. Similarly, the shapes of and positional relationships between constituent elements referred to in the following description are inclusive of those substantially close to or similar to them unless otherwise expressed or except when such shapes and positional relationships are apparently considered defined in principle. This also applies to the numeric values and ranges.

Note that the drawings referred to in describing the following embodiments may include plan views hatched to make them clearer. Also note that, in the drawings referred to in describing the following embodiments, parts having identical functions are denoted, as a rule, by identical reference numerals and that duplicate descriptions of such parts are omitted. The preferred embodiments of the present invention will be described in detail below with reference to the accompanying drawings.

### First Embodiment

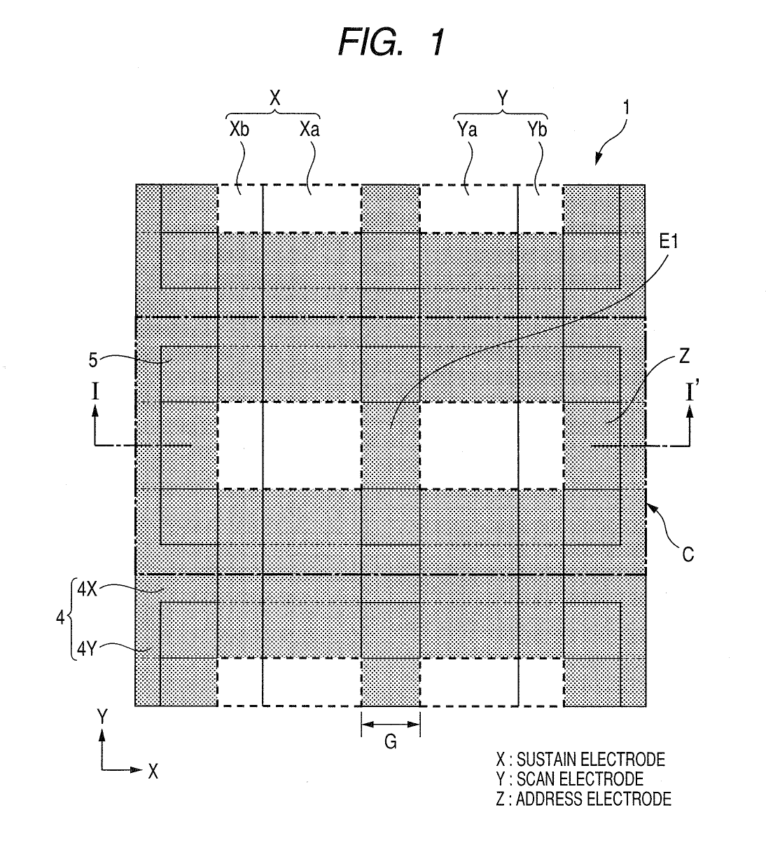

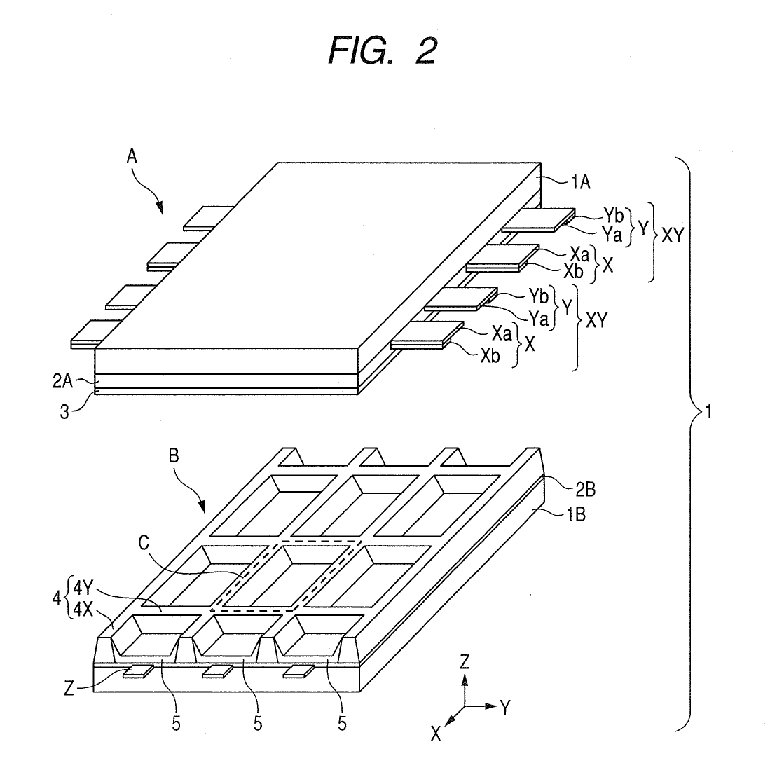

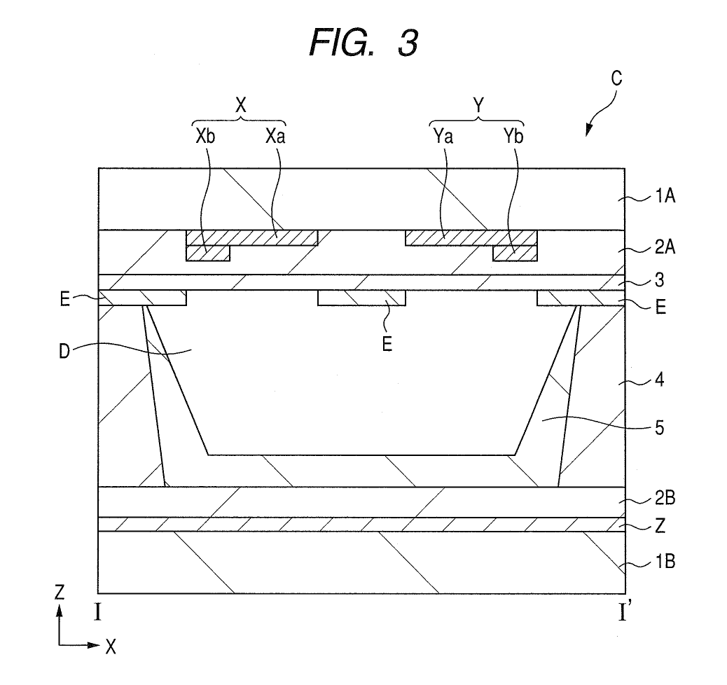

The PDP according to a first embodiment of the present invention will be described with reference to FIGS. 1 to 3. FIG. 1 is a partial front view schematically showing a part of a PDP cell structure. FIG. 2 is an exploded perspective view schematically showing a part of the PDP cell structure. FIG. 3 is a partial sectional view taken along line I—I′ in FIG. 1.

A PDP 1 is composed of a front plate A including a front substrate 1A made of glass and a back plate B including a back substrate 1B made of glass. The front plate A and the back plate B oppose each other across a discharge space D with plural discharge cells C formed between the two substrates.

To apply voltage to the discharge cells C, plural display electrode pairs XY are formed on the back side of the front substrate 1A with each pair including a sustain electrode X and a scan electrode Y which are spaced apart by a certain distance referred to as a discharge gap G and which extend, in parallel to each other, along a second direction (the Y-axis direction denoted in the drawings). The sustain electrode X includes a strip-shaped transparent electrode (a first transparent electrode) Xa and a bus electrode (a first bus electrode) Xb formed on the back side of the transparent electrode Xa. The width (a second width) of the bus electrode Xb is smaller than the width (a first width) of the transparent electrode Xa. Similarly, the scan electrode Y includes a strip-shaped transparent electrode (a second transparent electrode) Ya and a bus electrode (a second bus electrode) Yb formed on the back side of the transparent electrode Ya. The width (a fourth width) of the bus electrode Yb is smaller than the width (a third width) of the transparent electrode Ya. The transparent electrode Xa and the transparent electrode Ya are each formed of a transparent electrode material, for example, indium tin oxide (ITO) or zinc oxide (ZnO) so as to collect light emitted from a display surface. The bus electrode Xb and the bus electrode Yb are each formed of, for example, silver (Ag), a metallic film containing, for example, aluminum (Al), or a laminated film of, for example, chrome (Cr)/cupper (Cu)/chrome (Cr) so as to supplement the conductivity of the transparent electrodes.

The display electrode pairs XY are covered with a dielectric layer 2A of glass for insulation from AC discharge. The dielectric layer 2A is covered with a protective layer 3 of magnesium oxide (MgO).

The protective layer 3 plays, broadly classified, three roles. The first role is to insulate the dielectric layer 2A from plasma generated by discharge so as to protect the dielectric layer 2A from ion bombardment. The second role is to lower the discharge starting voltage by injecting ions and thereby inducing secondary electron emission. The third role is to generate and sustain plasma by emitting electrons to prime discharge or, particularly, to facilitate starting of discharge by emitting priming electrons which are charged particles. The priming electrons are electrons which can prime discharge.

The protective layer 3 has, on its back side, an electron emissive layer E formed of magnesium oxide crystals. The magnesium oxide crystals have a large secondary electron emission coefficient and function as an electron emitting material for reducing an address discharge delay.

Based on a front view of the discharge cells C, there are defined intersection regions (first regions) where the display electrode pairs XY and address electrodes Z intersect and a remaining region (a second region) E1 excluding the intersection regions. The remaining region (the second region) E1 is hatched in FIG. 1. The surface density of the magnesium oxide crystals forming the electron emissive layer E over the intersection regions (the first regions) is equal to or lower than half the surface density of the magnesium oxide crystals forming the electron emissive layer E over the remaining region (the second region).

On the display side of the back substrate 1B of glass, on the other hand, the address electrodes Z of, for example, silver are formed to extend, mutually in parallel, along the first direction (the X-axis direction denoted in the drawings) and to be spaced apart by a certain distance along the second direction (Y-axis direction). The address electrodes Z are covered with a dielectric layer 2B of glass. Ribs 4 also of glass are formed on the display side of the dielectric layer 2B. Between the ribs 4, phosphor layers 5 for emitting red, blue, and green light are formed cyclically along the second direction (Y-axis direction).

The ribs 4 include longitudinal ribs 4X each extending centrally between adjacent address electrodes Z (along the first direction (X-axis direction)) and transverse ribs 4Y each extending centrally between adjacent display electrode pairs XY (along the second direction (Y-axis direction), thereby forming a lattice pattern. The discharge space D formed between the front substrate 1A and the back substrate 1B is partitioned into the rectangular discharge cells C by the ribs 4.

The front substrate 1A and the back substrate 1B are placed to face each other such that, as seen in a front view of the discharge cells C, the display electrode pairs XY on the front substrate 1A side and the address electrodes Z on the back substrate 1B side approximately perpendicularly intersect (or, depending on the case, simply intersect), and are sealingly joined using low-melting-point glass (sealing glass) applied to peripheral edge portions of the substrates. The discharge space D, i.e. a gap formed between the two substrates, is filled with a discharge gas such as a mixture of Ne and Xe or a mixture of He, Ne, and Xe, and the plural discharge cells C are formed in the space. When the discharge gas is excited, vacuum ultraviolet rays are produced and excite the phosphor layers 5 formed on the back substrate 1B causing them to emit visible light. The PDP realizes full-color display using the phosphors to emit red, green, and blue light individually applied, as the phosphor layers 5, to each discharge cell C.

Even though, in this first embodiment, magnesium oxide is used as an electron emitting material, a different material, for example, an alkali metal oxide, an alkali earth metal oxide, an alkali metal fluoride, or an alkali earth metal fluoride with a small work function may also be used.

The method of producing magnesium oxide crystals to be used is not particularly defined, but it is preferable to use a gas phase method in which magnesium vapor generated by heating magnesium is made to react with oxygen. Preferable gas phase methods to be used include, for example, the method disclosed in JP-A-2004-182521 and the method described in “Synthesis of Magnesium Powder by Gas Phase Method and Properties of Synthesized Magnesium Powder” in Journal (ZAIRYO) of the Society of Materials Science, Japan, Vol. 36, No. 410, pp. 1157-1161 (November, 1987). The reason why using a gas phase method in producing magnesium oxide crystals is preferable is that high-purity single crystals can be obtained by using a gas phase method.

The method to be used to form the electron emissive layer E of magnesium oxide crystals is not defined. For example, the electron emissive layer E may be formed by preparing a mask having an opening corresponding to the shape of the electron emissive layer E, setting the mask with the opening positioned to form the electron emissive layer E, and depositing magnesium oxide crystals over the protective layer 3.

The method to be used to make magnesium oxide crystals adhere to the protective layer 3 is not defined. For example, magnesium oxide crystalline powder either as it is or in a state of being dispersed in a dispersion medium may be sprayed to the protective layer 3. Or, magnesium oxide crystals may be deposited on the protective layer 3 by screen printing. The electron emissive layer E may be formed by, instead of using a mask having an opening, depositing a paste or suspension containing magnesium oxide crystals where the electron emissive layer E is to be formed.

As described above, in the PDP according to this first embodiment, the protective layer 3 has, on its back side, the electron emissive layer E formed of magnesium oxide crystals. Based on a front view of the discharge cells C, there are defined intersection regions (first regions) where the display electrode pairs XY and address electrodes Z intersect and a remaining region (a second region) E1 excluding the intersection regions. The surface density of the magnesium oxide crystals forming the electron emissive layer E over the intersection regions (the first regions) is equal to or lower than half the surface density of the magnesium oxide crystals forming the electron emissive layer E over the remaining region (the second region).

As seen in a front view of the discharge cells C, in the remaining region (the second region) E1 where the display electrode pairs XY and the address electrodes Z do not intersect, an electron emissive layer E of magnesium oxide crystals is formed on the bus electrodes Xb and Yb and peripherally to the longitudinal ribs 4X. Since the bus electrodes Xb and Yb in the remaining region (the second region) E1 are spaced from the corresponding the edge of electrode on discharge gap side discharge gap with a high discharge intensity, the effect of ion bombardment resulting from sustain discharge is relatively small, so that the sputtering resistance of the protective layer 3 is not largely affected. In regions peripheral to the longitudinal ribs 4X of the display electrode pairs XY, the protective layer 3 is affected, in no small measure, by the electron emissive layer E when ion bombardment is caused by discharge. Since the plasma generated by discharge is confined within the discharge cells C, however, the effect of ion bombardment caused by discharge on the protective layer 3 portions facing the regions peripheral to the longitudinal ribs 4X of the display electrode pairs XY is relatively small, so that the sputtering resistance of the protective layer 3 is not much affected.

Thus, by forming the electron emissive layer E only in the remaining region (the second region) E1 that excludes the intersection regions (the first regions) where the display electrode pairs XY and the address electrodes Z intersect and that is not much affected by ion bombardment caused by discharge, the address discharge delay can be reduced without degrading the sputtering resistance of the protective layer 3.

In the regions (the first regions) in which the display electrode pairs XY and the address electrodes Z intersect, the surface density of the magnesium oxide crystals need not be strictly nil. Just keeping the surface density small is effective in reducing degradation of the protective layer 3 attributable to sputtering caused by the electron emissive layer E. When the discharge cells C are found to include regions (the first regions) where the electron emissive layer E has been positively formed and a region (the second region) where the surface density of magnesium oxide crystals is equal to or lower than half that in the first regions, it may be determined that the technique being described has been used. The density of the magnesium oxide crystals sprayed may continuously and moderately change over the border portions of the first regions where the electron emissive layer E of the magnesium oxide crystals has been positively formed.

In the technique disclosed in JP-A No. 2006-114484 referred to above, an electron emissive layer of magnesium oxide crystals (a crystalline magnesium oxide layer) is formed in regions including near the edge of the electrode on the discharge gap side with high field strength. It is, therefore, feared that protective layer degradation caused by sputtering is promoted near the edge of the electrode on the discharge gap side. According to the first embodiment, however, the electron emissive layer E is formed only in the remaining region (the second region) E1 not much affected by ion bombardment caused by discharge, so that it is possible to reduce the address discharge delay while inhibiting degradation caused by sputtering of the protective layer 3.

The PDP structure according to the first embodiment is not limited to the shapes of the sustain electrodes X and scan electrodes Y. Examples in which differently shaped electrodes are used will be described as third and fourth embodiments.

### Second Embodiment

According to the foregoing first embodiment, the electron emissive layer E is formed over the back side of the entire protective layer 3 portion in the second region E1 that excludes the intersection regions (the first regions) where the display electrode pairs XY and the address electrodes Z intersect. In a second embodiment, the electron emissive layer E is formed over the back side of parts of the protective layer 3 portion in the second region E1 that excludes the intersection regions (the first regions) where the display electrode pairs XY and the address electrodes Z intersect.

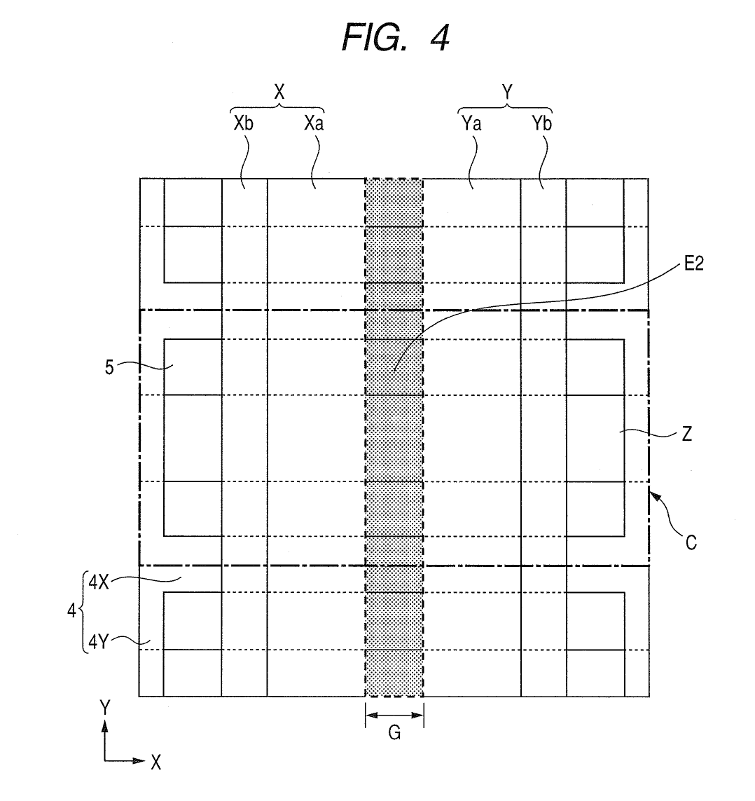

Six examples according to the second embodiment in which electron emissive layers are formed in respectively different regions will be described below with reference to FIGS. 4 to 9 corresponding to the six examples. FIGS. 4 to 9 are each a partial front view schematically showing a part of a PDP cell structure.

In the PDP according to a first example of the second embodiment, an electron emissive layer E of magnesium oxide crystals is formed, as shown in FIG. 4, in each strip-shaped region E2 extending between a sustain electrode X and a scan electrode Y along the second direction (Y-axis direction) and having a same width as that of a discharge gap G. The magnesium oxide crystals have a large secondary electron emission coefficient and serve as an electron emitting material.

By forming, as described above, the electron emissive layer E only in each strip-shaped region E2 extending between a sustain electrode X and a scan electrode Y and being almost free of the effect of ion bombardment caused by discharge, the address discharge delay can be reduced without degrading the sputtering resistance of the protective layer 3 at all.

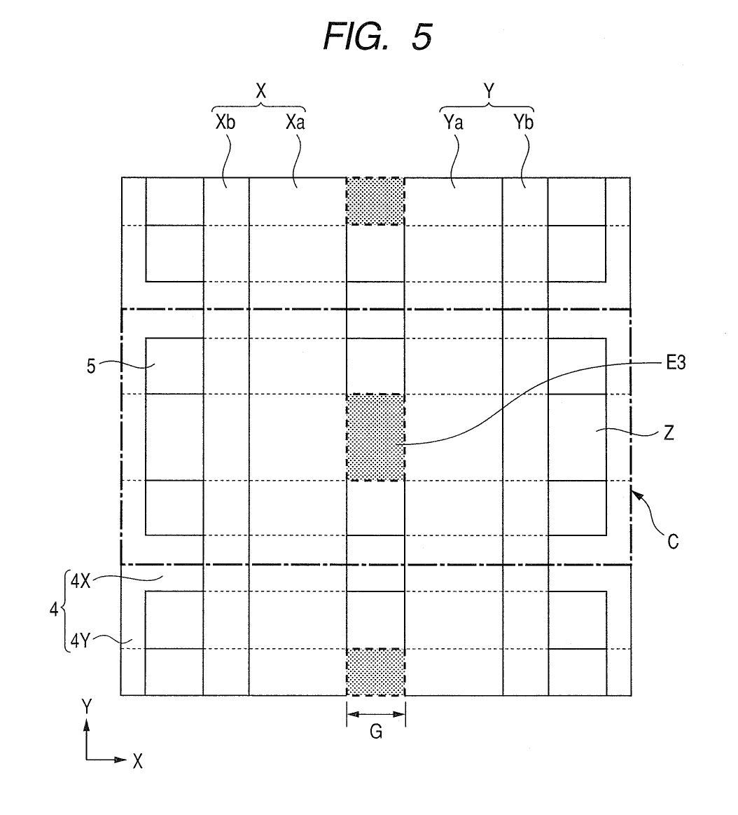

In the PDP according to a second example of the second embodiment, an electron emissive layer E of magnesium oxide crystals is formed, as shown in FIG. 5, in each rectangular region E3 extending between a sustain electrode X and a scan electrode Y along the second direction (Y-axis direction), having a same width as that of a discharge gap G, and being directly above an address electrode extending along the first direction (X-axis direction).

In this case, even though care must be taken not to cause mask misalignment in a production process, the amount of magnesium oxide crystals to be sprayed to form the electron emissive layer E can be reduced for a cost reduction and, by forming the electron emissive layer E on the back side of the protective layer 3 opposing the address electrode Z, the address discharge delay can be effectively reduced.

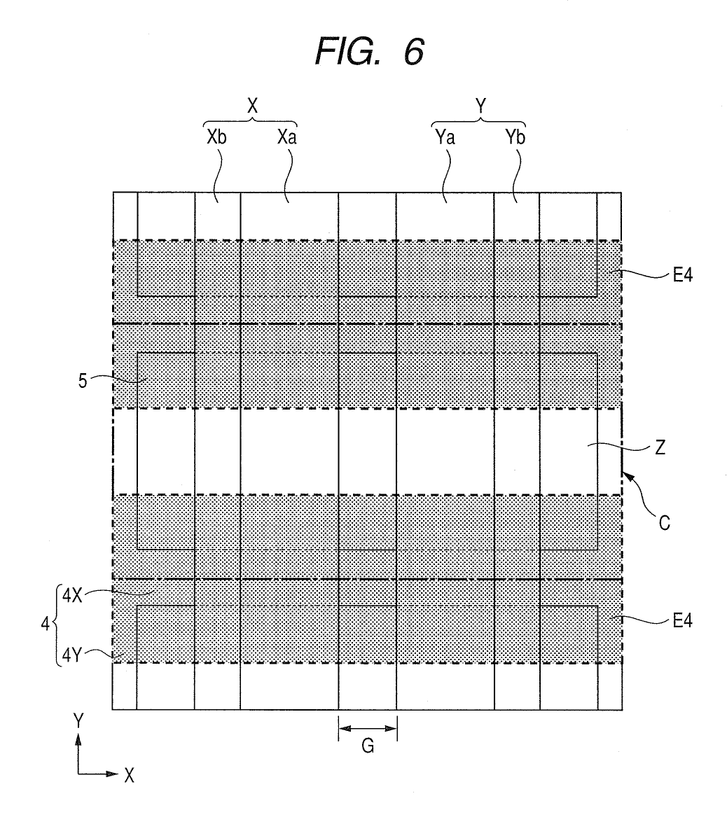

In the PDP according to a third example of the second embodiment, an electron emissive layer E of magnesium oxide crystals is formed, as shown in FIG. 6, in each strip-shaped region E4 extending peripherally to a longitudinal rib 4X along the first direction (X-axis direction). Preferably, each region E4 is not directly above any address electrode Z.

In this case, the electron emissive layer E is formed to overlap, as seen in a front view of the discharge cells C, with the sustain electrodes X and the scan electrodes Y, so that the protective layer 3 is affected, in no small measure, by the electron emissive layer E when ion bombardment is caused by discharge. Since the plasma generated by discharge is confined within the discharge cells C, however, the effect of ion bombardment caused by discharge on the protective layer 3 portions facing the regions peripheral to the longitudinal ribs 4X is relatively small. On the other hand, the electron emissive layer E is formed on parts of the back side of the transparent electrodes Xa and Ya. It is therefore possible to effectively reduce the address discharge delay by making use of the electrostatic field generated over such parts.

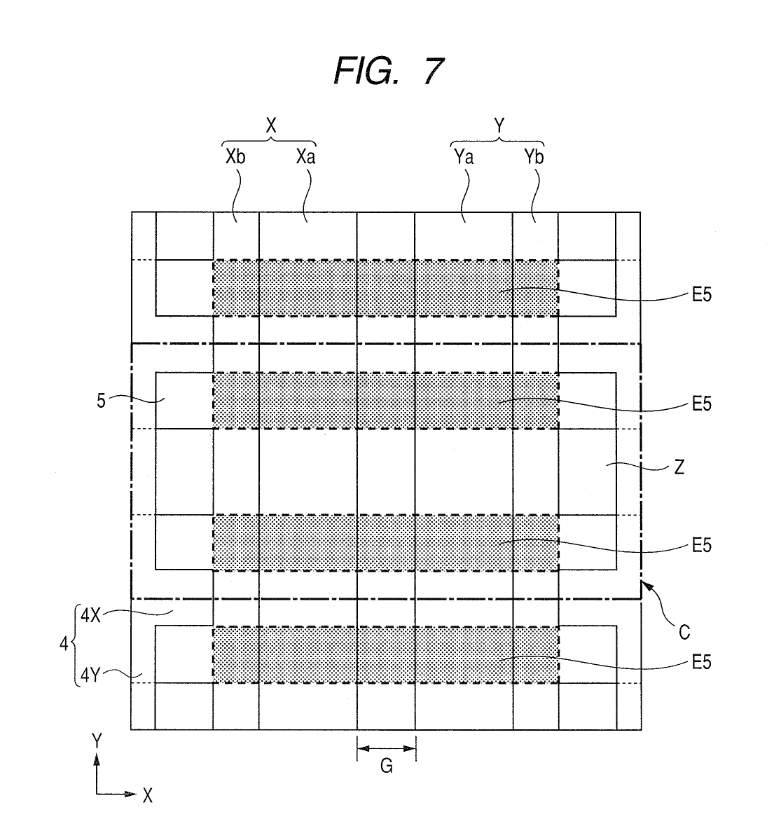

In the PDP according to a fourth example of the second embodiment, an electron emissive layer E of magnesium oxide crystals is formed, as shown in FIG. 7, in each rectangular region E5 extending peripherally to a longitudinal rib 4X along the first direction (X-axis direction) to overlap, as seen in a front view of the discharge cells C, with a sustain electrode X, a scan electrode Y, and the region between the two electrodes. Preferably, each region E5 is not directly above any longitudinal rib 4X or any address electrode Z.

In this case, even though care must be taken not to cause mask misalignment in a production process, the amount of magnesium oxide crystals to be sprayed to form the electron emissive layer E can be further reduced for a cost reduction.

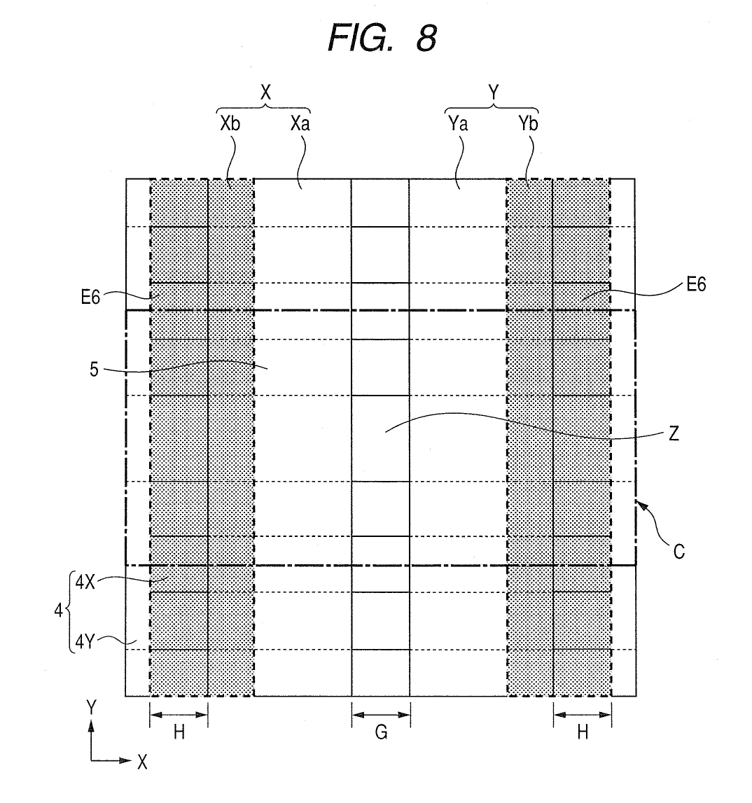

In the PDP according to a fifth example of the second embodiment, an electron emissive layer E of magnesium oxide crystals is formed, as shown in FIG. 8, in each strip-shaped region E6 including a bus electrode Xb or Yb and a gap H between, in the first direction (X-axis direction), the bus electrode Xb or Yb and the adjacent discharge cell C.

In this case, sustain discharge takes place between a pair of a transparent electrode Xa and a transparent electrode Ya within each discharge cell C, so that the adjacency gaps H are not affected by ion bombardment caused by discharge. Since the bus electrodes Xb and Yb are spaced from the discharge gap G with a high discharge intensity, the effect of ion bombardment caused by discharge on the bus electrodes Xb and Yb is relatively small and the sputtering resistance of the protective layer 3 is not much affected. Also, the electron emissive layer E is formed in each region E6 including a bus electrode Xb or Yb and an adjacency gap H not to block the light transmitted through the discharge gap G and the transparent electrodes Xa and Ya. It is therefore possible to effectively reduce the address discharge delay by making use of the electrostatic fields of the bus electrode's Xb and Yb while suppressing lowering of the optical transmission ratio.

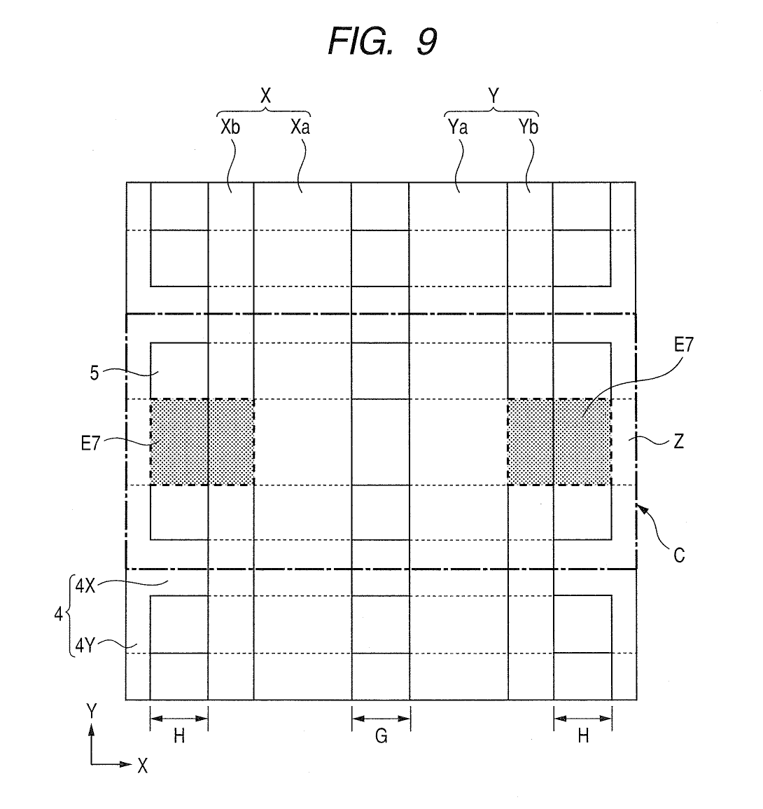

In the PDP according to a sixth example of the second embodiment, an electron emissive layer of magnesium oxide crystals is formed, as shown in FIG. 9, in each rectangular region E7 including a bus electrode Xb or Yb and an adjacency gap H and being directly above an address electrode Z.

In this case, even though care must be taken not to cause mask misalignment in a production process, the amount of magnesium oxide crystals to be sprayed to form the electron emissive layer E can be reduced for a cost reduction, and the address discharge delay can be effectively reduced by forming the electron emissive layer E on the protective layer 3 portions facing the address electrodes Z.

### Third Embodiment

According to the first and second embodiments described above, the transparent electrodes Xa and Ya included in the PDP are each strip-shaped. In a third embodiment, the transparent electrodes Xa and Ya included in the PDP each have a T-shaped projecting part formed, for each discharge cell C, directly above an address electrode Z.

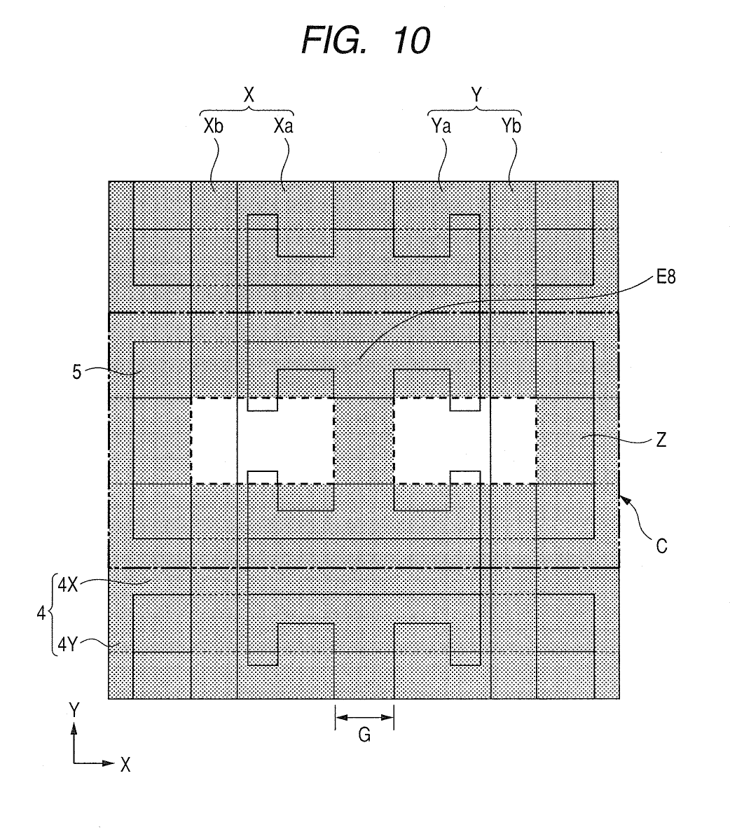

Seven examples according to the third embodiment in which electron emissive layers are formed in respectively different regions will be described below with reference to FIGS. 10 to 16 corresponding to the seven examples. FIGS. 10 to 16 are each a partial front view schematically showing a part of a PDP cell structure. The PDP structure of the third embodiment is the same as that of the first and second embodiments except that, in the third embodiment, the transparent electrodes Xa and Ya each have a T-shaped part corresponding to each discharge cell C.

In the PDP according to a first example of the third embodiment, an electron emissive layer E of magnesium oxide crystals is formed, as shown in FIG. 10 and as in the PDP according to the first embodiment, in a second region E8 which excludes intersection regions (first regions) where the display electrode pairs XY and the address electrodes Z intersect and which is not much affected by ion bombardment caused by discharge.

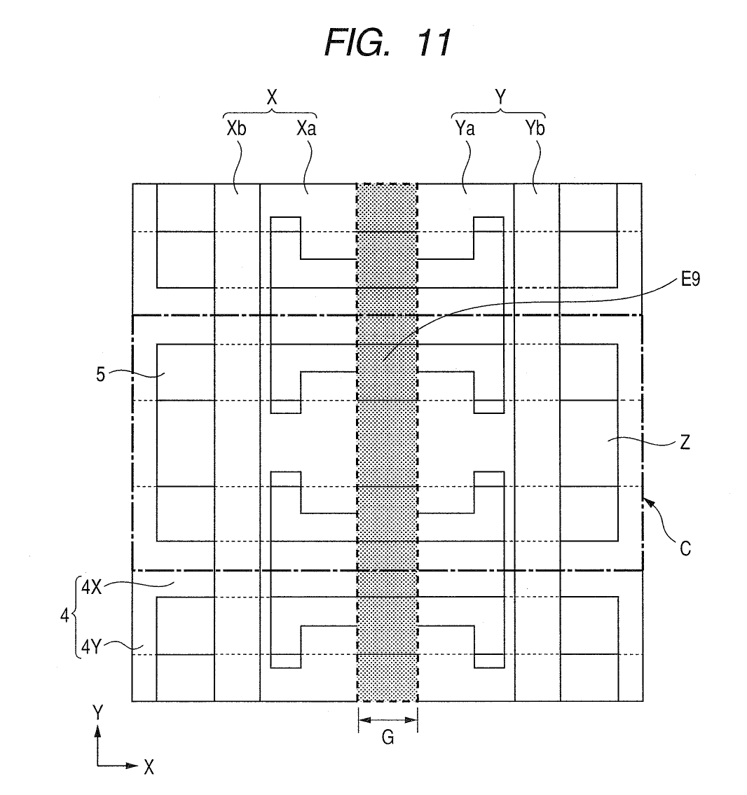

In the PDP according to a second example of the third embodiment, an electron emissive layer E of magnesium oxide crystals is formed, as shown in FIG. 11 and as in the PDP according to the first example (shown in FIG. 4) of the second embodiment, in each strip-shaped region E9 extending, along the second direction (Y-axis direction), between the projecting parts of the transparent electrode Xa included in a sustain electrode X and the projecting parts of the transparent electrode Ya included in a scan electrode Y and having a same width as that of a discharge gap G.

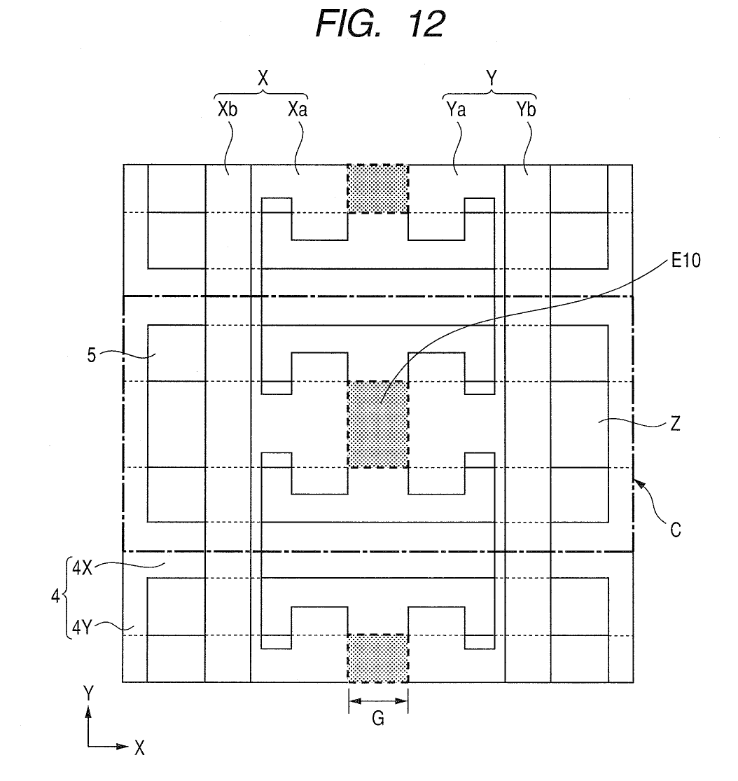

In the PDP according to a third example of the third embodiment, an electron emissive layer E of magnesium oxide crystals is formed, as shown in FIG. 12 and as in the PDP according to the second example (shown in FIG. 5) of the second embodiment, in each rectangular region E10 extending, along the second direction (Y-axis direction), between a projecting part of the transparent electrode Xa included in a sustain electrode X and an opposed projecting part of the transparent electrode Ya included in a scan electrode Y, having a same width as that of a discharge gap G, and being directly above an address electrode extending along the first direction (X-axis direction).

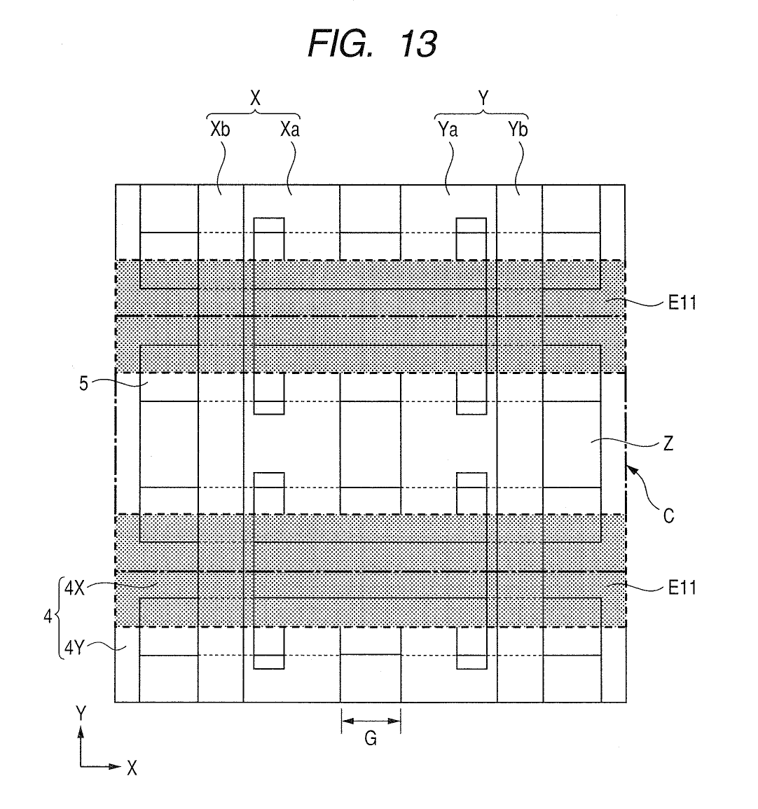

In the PDP according to a fourth example of the third embodiment, an electron emissive layer E of magnesium oxide crystals is formed, as shown in FIG. 13 and as in the PDP according to the third example (shown in FIG. 6) of the second embodiment, in each strip-shaped region E11 extending peripherally to a longitudinal rib 4X along the first direction (X-axis direction). Preferably, each region E11 is not directly above any address electrode Z and it does not overlap with any wide portion of any T-shaped projecting part of any transparent electrode Xa or Ya.

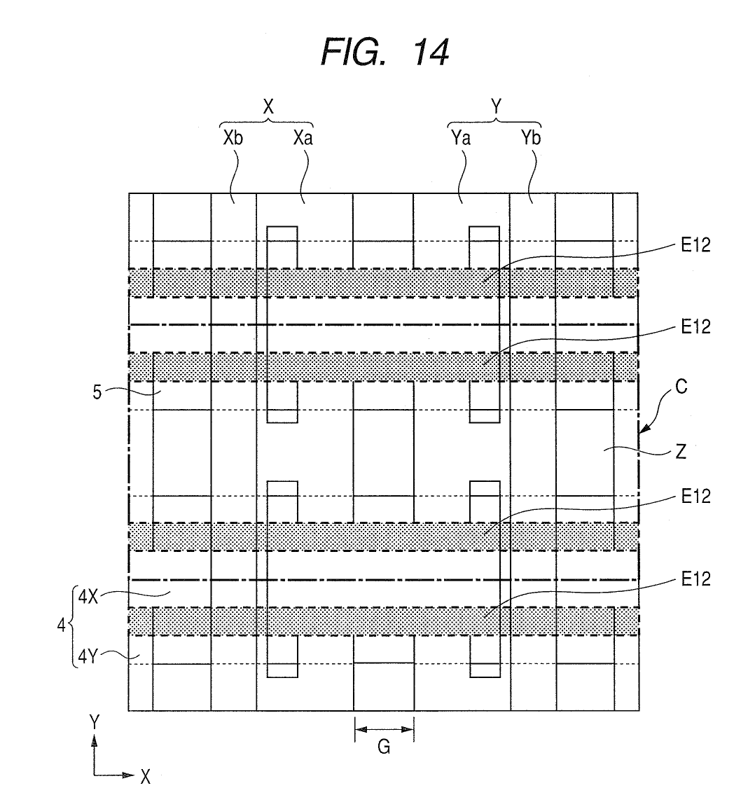

In the PDP according to a fifth example of the third embodiment, an electron emissive layer E of magnesium oxide crystals is formed, as shown in FIG. 14 and as in the PDP according to the fourth example (shown in FIG. 7) of the second embodiment, in each strip-shaped region E12 extending peripherally to a longitudinal rib 4X along the first direction (X-axis direction). Preferably, each region E12 is not directly above any longitudinal rib 4X or any address electrode Z and it does not overlap with any wide portion of any T-shaped projecting part of any transparent electrode Xa or Ya.

In the PDP according to a sixth example of the third embodiment, an electron emissive layer E of magnesium oxide crystals is formed, as shown in FIG. 15 and as in the PDP according to the fifth example (shown in FIG. 8) of the second embodiment, in each strip-shaped region E13 including a bus electrode Xb or Yb and a gap H formed adjacently to the bus electrode Xb or Yb.

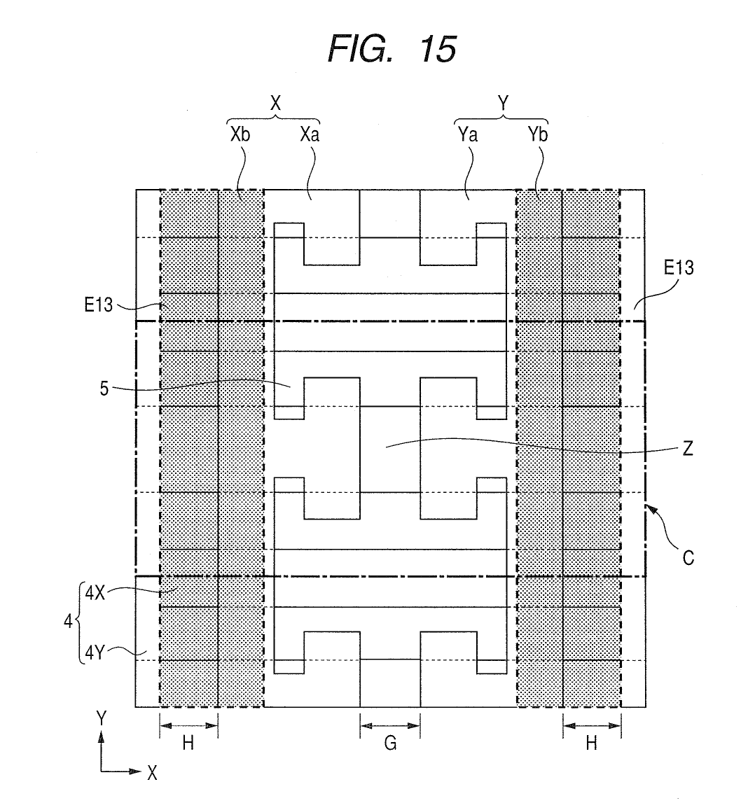

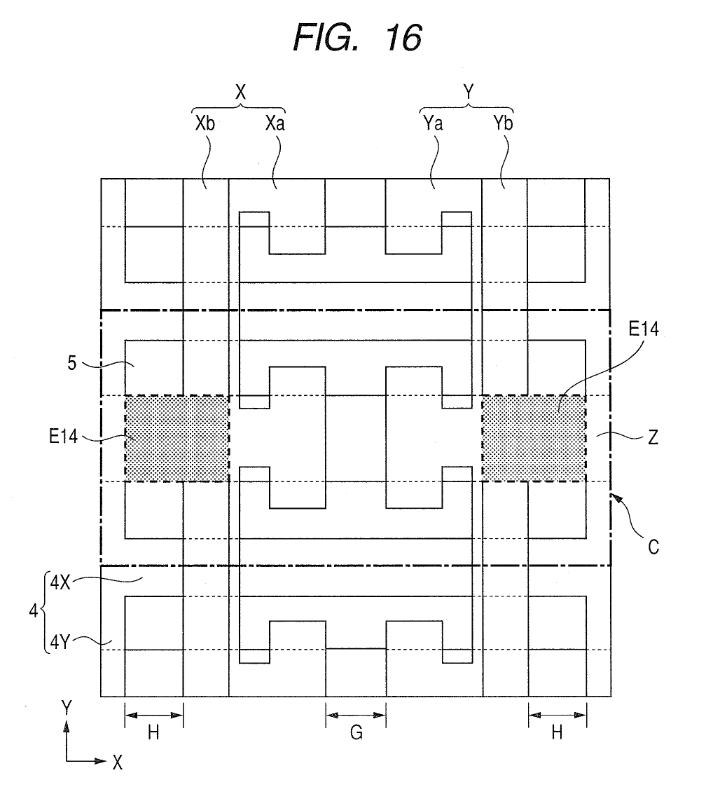

In the PDP according to a seventh example of the third embodiment, an electron emissive layer E of magnesium oxide crystals is formed, as shown in FIG. 16 and as in the PDP according to the sixth example (shown in FIG. 9) of the second embodiment, in each rectangular region E14 including a bus electrode Xb or Yb and a gap H formed adjacently to the bus electrode Xb or Yb and being directly above an address electrode Z.

As described above, according to the third embodiment, even in cases where transparent electrodes Xa and Ya included in a PDP have T-shaped parts each formed directly above an address electrode Z, the address discharge delay can be reduced without degrading the sputtering resistance of the protective layer 3 by forming, on the back side of the protective layer 3, an electron emissive layer E only in a region (E8) which is not much affected by ion bombardment caused by discharge or only in parts (E9 to E14) of such region.

### Fourth Embodiment

According to the first and second embodiments described above, the sustain electrodes X (the transparent electrodes Xa and bus electrodes Xb) and the scan electrodes Y (the transparent electrodes Ya and bus electrodes Yb) included in the PDP are each strip-shaped. In a fourth embodiment, the sustain electrodes X (the transparent electrodes Xa and bus electrodes Xb) and the scan electrodes Y (the transparent electrodes Ya and bus electrodes Yb) included in the PDP each have a projecting part, formed directly above an address electrode Z, for each discharge cell C.

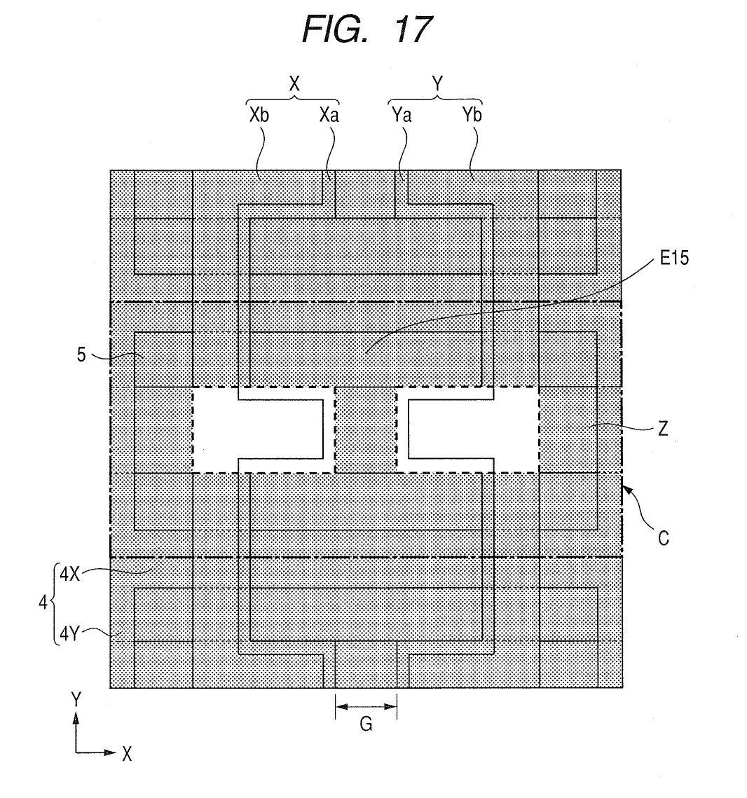

Seven examples according to the fourth embodiment in which electron emissive layers are formed in respectively different regions will be described below with reference to FIGS. 17 to 23 corresponding to the seven examples. FIGS. 17 to 23 are each a partial front view schematically showing a part of a PDP cell structure. The PDP structure of the fourth embodiment is the same as that of the first and second embodiments except that, in the fourth embodiment, the sustain electrodes X (the transparent electrodes Xa and bus electrodes Xb) and the scan electrodes Y (the transparent electrodes Ya and bus electrodes Yb) each have a projecting part for each discharge cell C.

In the PDP according to a first example of the fourth embodiment, an electron emissive layer E of magnesium oxide crystals is formed, as shown in FIG. 17 and as in the PDP according to the first embodiment, in a second region E15 which excludes intersection regions (first regions) where the display electrode pairs XY and the address electrodes Z intersect and which is not much affected by ion bombardment caused by discharge.

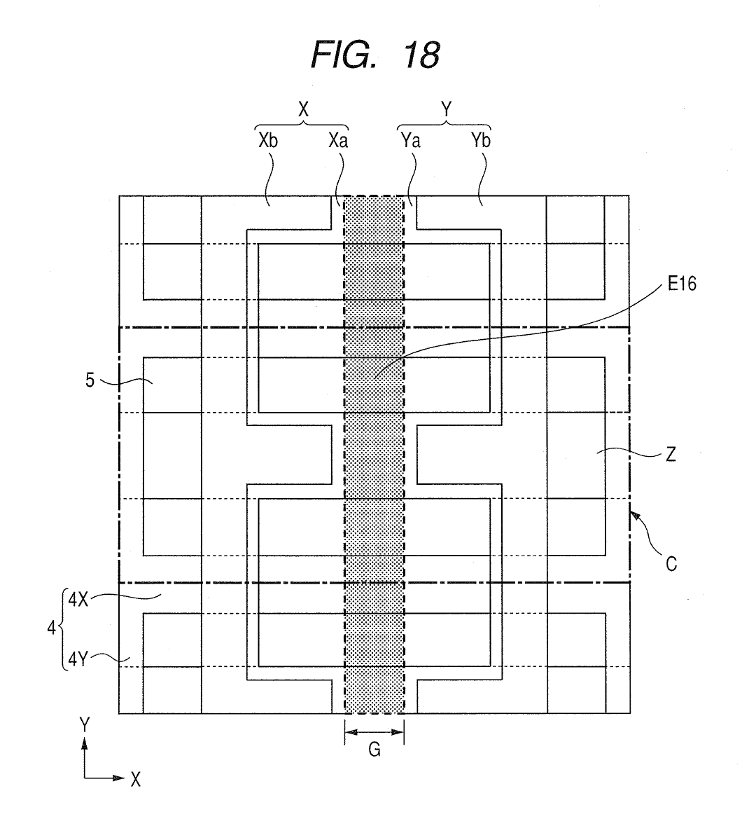

In the PDP according to a second example of the fourth embodiment, an electron emissive layer E of magnesium oxide crystals is formed, as shown in FIG. 18 and as in the PDP according to the first example (shown in FIG. 4) of the second embodiment, in each strip-shaped region E16 extending, in the second direction (Y-axis direction), between a sustain electrode X and a scan electrode Y and having a same width as that of a discharge gap G.

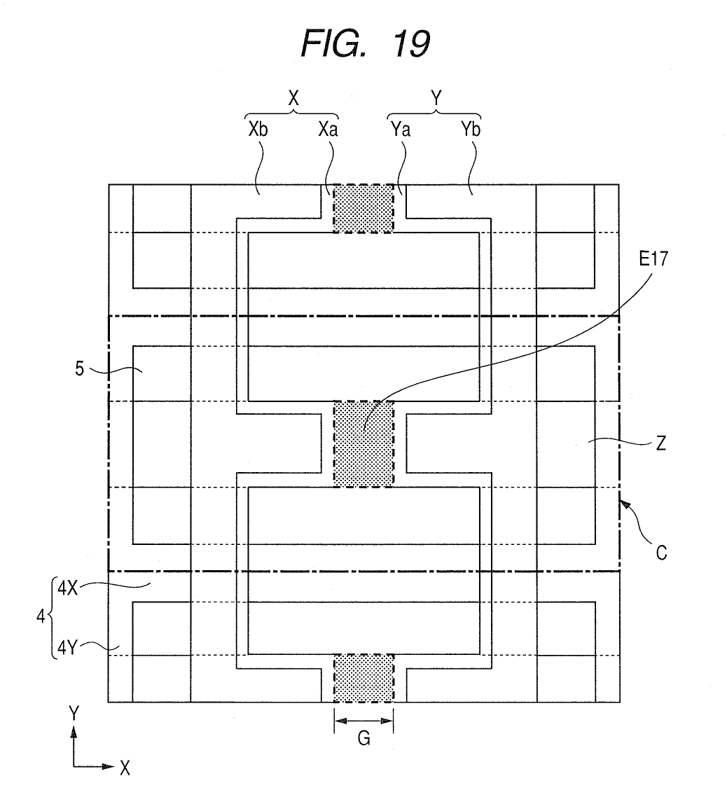

In the PDP according to a third example of the fourth embodiment, an electron emissive layer E of magnesium oxide crystals is formed, as shown in FIG. 19 and as in the PDP according to the second example (shown in FIG. 5) of the second embodiment, in each rectangular region E17 extending, in the second direction (Y-axis direction), between a sustain electrode X and a scan electrode Y, having a same width as that of a discharge gap G, and being directly above an address electrode Z extending in the first direction (X-axis direction).

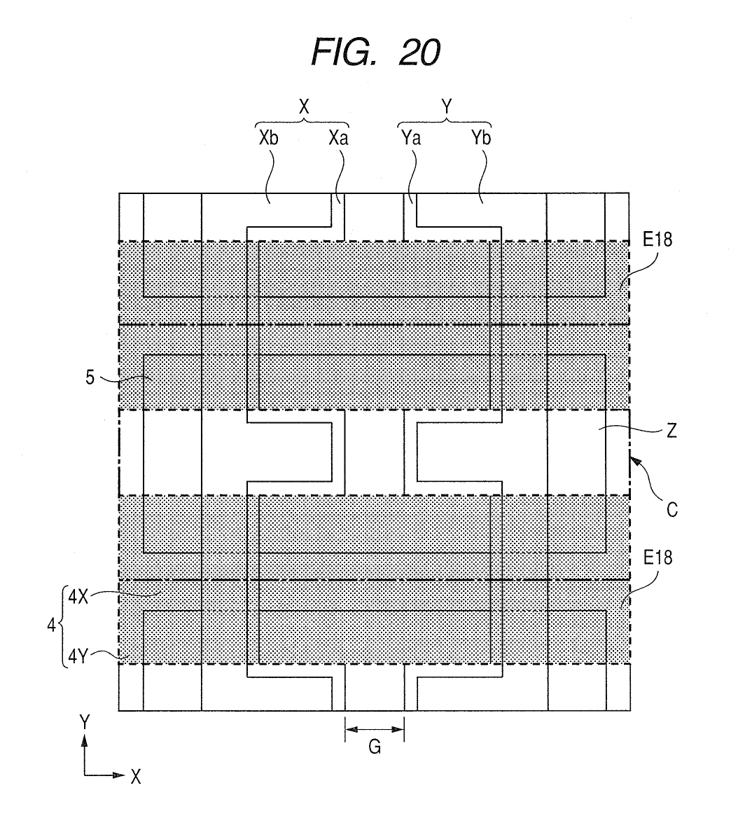

In the PDP according to a fourth example of the fourth embodiment, an electron emissive layer E of magnesium oxide crystals is formed, as shown in FIG. 20 and as in the PDP according to the third example (shown in FIG. 6) of the second embodiment, in each strip-shaped region E18 extending peripherally to a longitudinal rib 4X along the first direction (X-axis direction). Preferably, each region E18 is not directly above any address electrode Z and it does not overlap with any projecting part of any sustain electrode X or scan electrode Y.

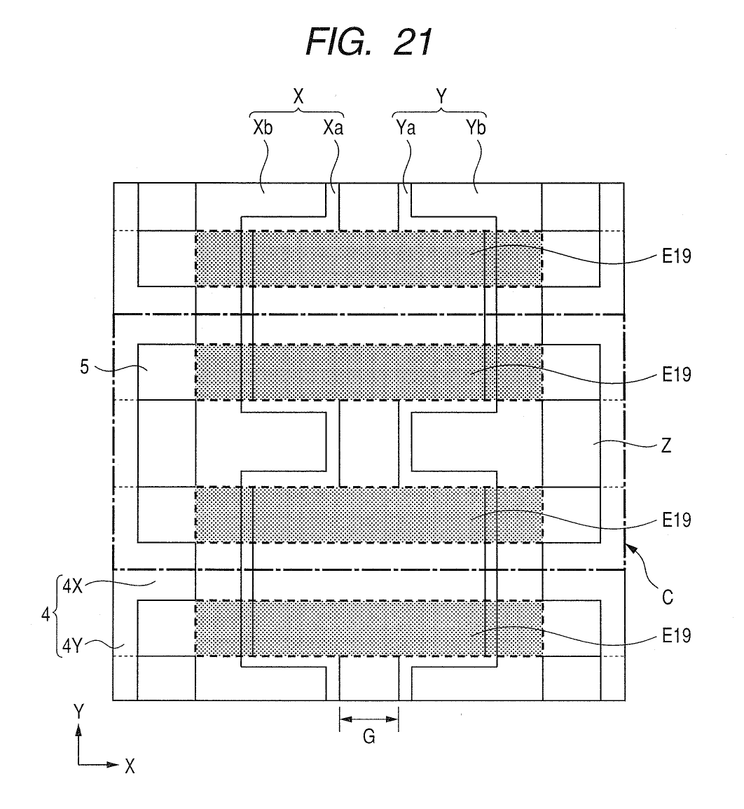

In the PDP according to a fifth example of the fourth embodiment, an electron emissive layer E of magnesium oxide crystals is formed, as shown in FIG. 21 and as in the PDP according to the fourth example (shown in FIG. 7) of the second embodiment, in each rectangular region E19 extending peripherally to a longitudinal rib 4X along the first direction (X-axis direction) to overlap, as seen in a front view of the discharge cells C, with a sustain electrode X, a scan electrode Y, and the region between the two electrodes. Preferably, each region E19 is not directly above any longitudinal rib 4X or any address electrode Z and it does not overlap with any projecting part of any sustain electrode X or scan electrode Y.

In the PDP according to a sixth example of the fourth embodiment, an electron emissive layer E of magnesium oxide crystals is formed, as shown in FIG. 22 and as in the PDP according to the fifth example (shown in FIG. 8) of the second embodiment, in each strip-shaped region E20 including a bus electrode Xb or Yb and a gap H formed adjacently to the bus electrode Xb or Yb.

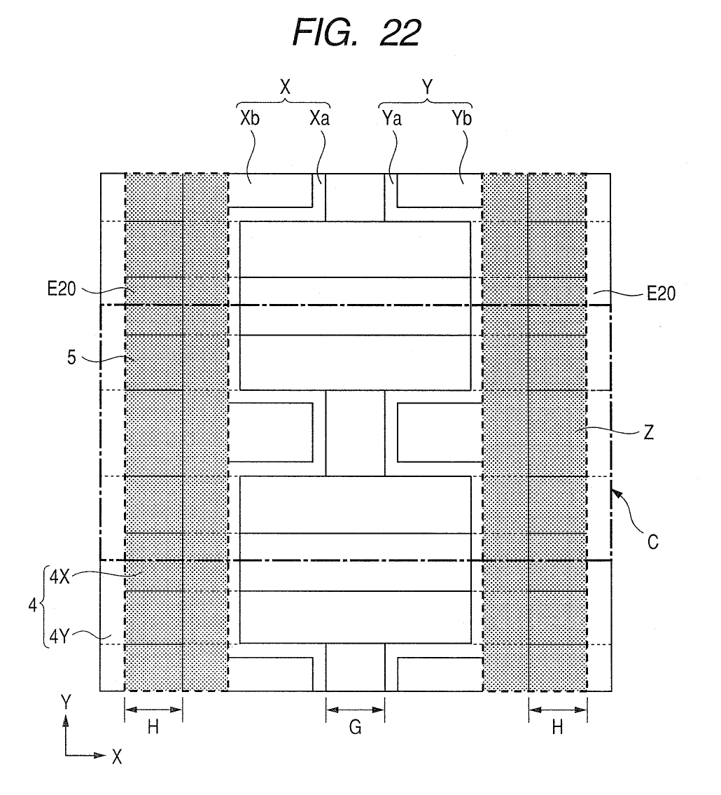

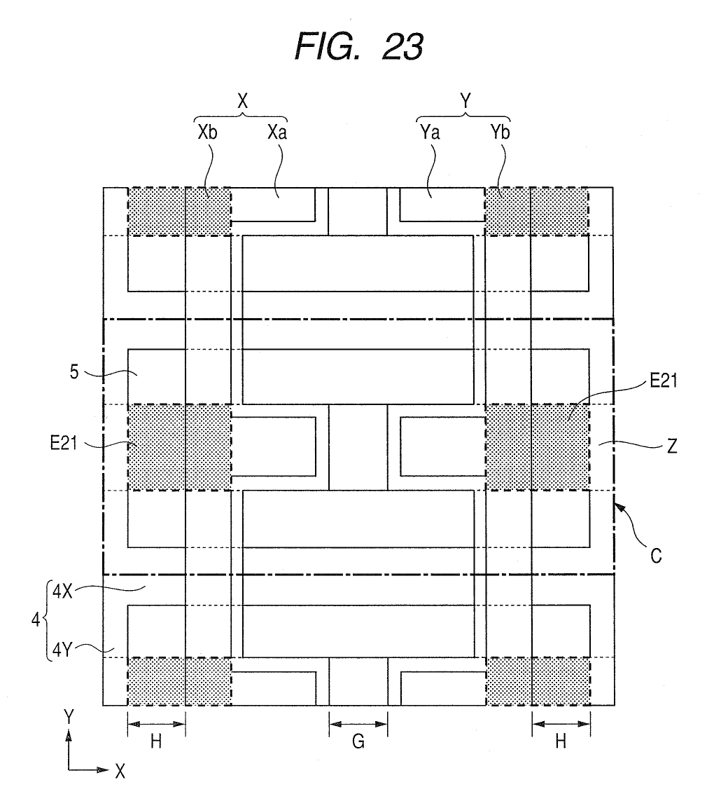

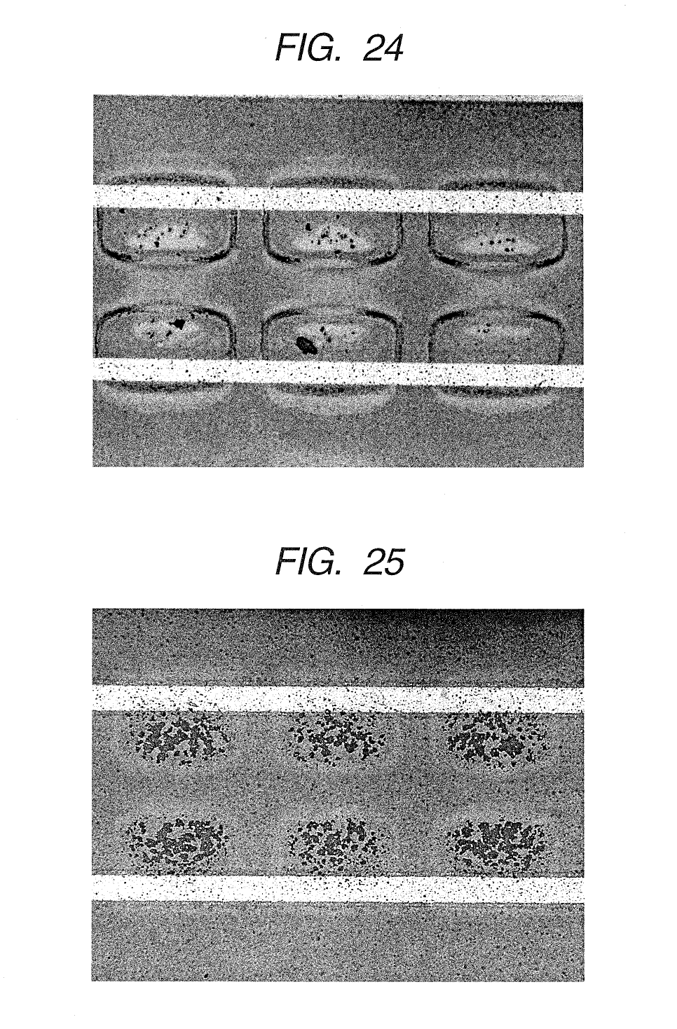

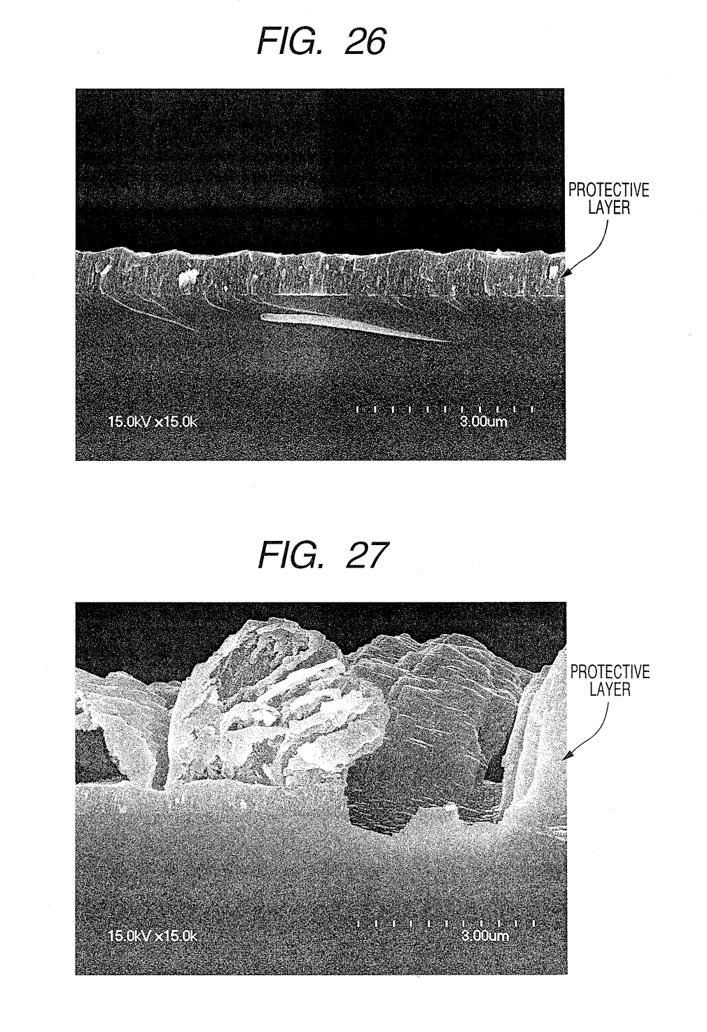

In the PDP according to a seventh example of the fourth embodiment, an electron emissive layer E of magnesium oxide crystals is formed, as shown in FIG. 23 and as in the PDP according to the sixth example (shown in FIG. 9) of the second embodiment, in each rectangular region E21 including a bus electrode Xb or Yb and a gap H formed adjacently to the bus electrode Xb or Yb and being directly above an address electrode Z.

As described above, according to the fourth embodiment, even in cases where sustain electrodes X and scan electrodes Y included in a PDP each have a projecting part formed, for each discharge cell C, directly above an address electrode Z, the address discharge delay can be reduced without degrading the sputtering resistance of the protective layer 3 by forming, on the back side of the protective layer 3, an electron emissive layer E only in a region (E15) which does not include any projecting part of any sustain electrode X or scan electrode Y and which is not much affected by ion bombardment caused by discharge or only in parts (E16 to E21) of such region.

The invention made by the present inventors has been concretely described based on embodiments, but the invention is not limited to the embodiments and it can be modified in various ways without departing from the scope of the invention.

The present invention can be applied to AC surface discharge type PDPs mainly used in display devices such as TVs.

What is claimed is:

1. A plasma display panel comprising:
a front substrate and a back substrate opposing each other across a discharge space;
a plurality of display electrode pairs, each pair including a sustain electrode and a scan electrode which are arranged, on a back side of the front substrate, along a first direction to be spaced apart by a discharge gap having a predetermined width and which extend along a second direction perpendicular to the first direction;
a dielectric layer covering the display electrode pairs;
a protective layer covering the dielectric layer;
a plurality of address electrodes arranged on a display side of the back substrate and extending along the first direction; and
a plurality of discharge cells formed by the display electrode pairs and the address electrodes facing each other across the discharge space;
wherein an electron emissive layer including magnesium oxide crystals is formed on a back side of the protective layer;
wherein there are defined a plurality of intersection regions in which the display electrode pairs and the address electrodes intersect as seen in a front view of the discharge cells and a remaining region excluding the intersection regions; and
wherein the surface density of the magnesium oxide crystals included in the electron emissive layer in the intersection regions is equal to or lower than half the surface density of the magnesium oxide crystals included in the electron emissive layer in a whole or part of the remaining region.

2. The plasma display panel according to claim 1, wherein the part of the remaining region is a strip-shaped region extending, along the second direction, between one of the sustain electrodes and one of the scan electrodes and having a same width as the width of the discharge gap.

3. The plasma display panel according to claim 1, wherein the part of the remaining region is a rectangular region extending, along the second direction, between one of the sustain electrodes and one of the scan electrodes, having a same width as the width of the discharge gap, and being directly above one of the address electrodes.

4. The plasma display panel according to claim 1,
wherein the discharge cells are partitioned by a plurality of longitudinal ribs extending along the first direction and a plurality of transverse ribs extending along the second direction; and
wherein the part of the remaining region is a strip-shaped region extending peripherally to one of the longitudinal ribs and not being directly above any of the address electrodes.

5. The plasma display panel according to claim 1,
wherein the discharge cells are partitioned by a plurality of longitudinal ribs extending along the first direction and a plurality of transverse ribs extending along the second direction; and
wherein the part of the remaining region is a rectangular first region extending peripherally to one of the longitudinal ribs along the first direction, the rectangular first region overlapping, as seen in a front view of the discharge cells, with one of the sustain electrodes, one of the scan electrodes, and space between the one of the sustain electrodes and the one of the scan electrodes and not being directly above any of the longitudinal ribs and any of the address electrodes.

6. The plasma display panel according to claim 1,
wherein the sustain electrodes each include a first transparent electrode having a first width and a first bus electrode formed on a back side of the first transparent electrode and having a second width smaller than the first width and the scan electrodes each include a second transparent electrode having a third width and a second bus electrode formed on a back side of the second transparent electrode and having a fourth width smaller than the third width; and
wherein the part of the remaining region is a strip-shaped region including one of the first bus electrodes or one of the second bus electrodes and a gap formed, adjacently to the one of the first bus electrodes or the one of the second bus electrodes, to extend along the second direction between adjacent two of the discharge cells adjacent along the first direction.

7. The plasma display panel according to claim 1,
wherein the sustain electrodes each include a first transparent electrode having a first width and a first bus electrode formed on a back side of the first transparent electrode and having a second width smaller than the first width and the scan electrodes each include a second transparent electrode having a third width and a second bus electrode formed on a back side of the second transparent electrode and having a fourth width smaller than the third width; and
wherein the part of the remaining region is a rectangular region including one of the first bus electrodes or one of the second bus electrodes and a gap formed, adjacently to the one of the first bus electrodes or the one of the second bus electrodes, to extend along the second direction between adjacent two of the discharge cells adjacent along the first direction and being directly above one of the address electrodes.

8. A plasma display panel comprising:
a front substrate and a back substrate opposing each other across a discharge space;
a plurality of display electrode pairs, each pair including a sustain electrode and a scan electrode which are arranged, on a back side of the front substrate, along a first direction to be spaced apart by a discharge gap having a predetermined width and which extend along a second direction perpendicular to the first direction;
a dielectric layer covering the display electrode pairs;
a protective layer covering the dielectric layer;
a plurality of address electrodes arranged on a display side of the back substrate and extending along the first direction; and
a plurality of discharge cells formed by the display electrode pairs and the address electrodes facing each other across the discharge space;
wherein the sustain electrodes each include a first transparent electrode having a T-shaped projecting part directly above one of the address electrodes and a strip-shaped first bus electrode formed on a back side of the first transparent electrode and the scan electrodes each include a second transparent electrode having a T-shaped projecting part directly above one of the address electrodes and a strip-shaped second bus electrode formed on a back side of the second transparent electrode;
wherein an electron emissive layer including magnesium oxide crystals is formed on a back side of the protective layer;
wherein there are defined a plurality of intersection regions in which the display electrode pairs and the address electrodes intersect as seen in a front view of the discharge cells and a remaining region excluding the intersection regions; and
wherein the surface density of the magnesium oxide crystals included in the electron emissive layer in the intersection regions is equal to or lower than half the surface density of the magnesium oxide crystals included in the electron emissive layer in a whole or part of the remaining region.

9. The plasma display panel according to claim 8, wherein the part of the remaining region is a strip-shaped region extending, along the second direction, between the projecting part of the first transparent electrode included in one of the sustain electrodes and the projecting part of the second transparent electrode included in one of the scan electrodes and having a same width as the discharge gap.

10. The plasma display panel according to claim 8, wherein the part of the remaining region is a rectangular region extending, along the second direction, between the projecting part of the first transparent electrode included in one of the sustain electrodes and the projecting part of the second transparent electrode included in one of the scan electrodes, having a same width as the discharge gap, and being directly above one of the address electrodes.

11. The plasma display panel according to claim 8,
wherein the discharge cells are partitioned by a plurality of longitudinal ribs extending along the first direction and a plurality of transverse ribs extending along the second direction; and
wherein the part of the remaining region is a strip-shaped region extending peripherally to one of the longitudinal ribs, not being directly above any of the address electrodes, and not overlapping with any wide portion of the projecting part of any first transparent electrode included in the sustain electrodes or any wide portion of the projecting part of any second transparent electrode included in the scan electrodes.

12. The plasma display panel according to claim 8,
wherein the discharge cells are partitioned by a plurality of longitudinal ribs extending along the first direction and a plurality of transverse ribs extending along the second direction; and
wherein the part of the remaining region is a strip-shaped first region extending peripherally to one of the longitudinal ribs along the first direction, not being directly above any of the longitudinal ribs and any of the address electrodes, and not overlapping with any wide portion of the projecting part of any first transparent electrode included in the sustain electrodes or any wide portion of the projecting part of any second transparent electrode included in the scan electrodes.

13. The plasma display panel according to claim 8,
wherein the sustain electrodes each include a first transparent electrode having a first width and a first bus electrode formed on a back side of the first transparent electrode and having a second width smaller than the first width and the scan electrodes each include a second transparent electrode having a third width and a second bus electrode formed on a back side of the second transparent electrode and having a fourth width smaller than the third width; and
wherein the part of the remaining region is a strip-shaped region including one of the first bus electrodes or one of the second bus electrodes and a gap formed, adjacently to the one of the first bus electrodes or the one of the second bus electrodes, to extend along the second direction between adjacent two of the discharge cells adjacent along the first direction.

14. The plasma display panel according to claim 8,
wherein the sustain electrodes each include a first transparent electrode having a first width and a first bus electrode formed on a back side of the first transparent electrode and having a second width smaller than the first width and the scan electrodes each include a second transparent electrode having a third width and a second bus electrode formed on a back side of the second transparent electrode and having a fourth width smaller than the third width; and
wherein the part of the remaining region is a rectangular region including one of the first bus electrodes or one of the second bus electrodes and a gap formed, adjacently to the one of the first bus electrodes or the one of the second bus electrodes, to extend along the second direction between adjacent two of the discharge cells adjacent along the first direction and being directly above one of the address electrodes.

15. A plasma display panel comprising:
a front substrate and a back substrate opposing each other across a discharge space;
a plurality of display electrode pairs, each pair including a sustain electrode and a scan electrode which are arranged, on a back side of the front substrate, along a first direction to be spaced apart by a discharge gap having a predetermined width and which extend along a second direction perpendicular to the first direction;
a dielectric layer covering the display electrode pairs;
a protective layer covering the dielectric layer;
a plurality of address electrodes arranged on a display side of the back substrate and extending along the first direction; and
a plurality of discharge cells formed by the display electrode pairs and the address electrodes facing each other across the discharge space;
wherein the sustain electrodes each include a first transparent electrode having a projecting part directly above one of the address electrodes and a first bus electrode and the scan electrodes each include a second transparent electrode having a projecting part directly above one of the address electrodes and a second bus electrode;
wherein an electron emissive layer including magnesium oxide crystals is formed on a back side of the protective layer;
wherein there are defined a plurality of intersection regions in which the display electrode pairs and the address electrodes intersect as seen in a front view of the discharge cells and a remaining region excluding the intersection regions; and
wherein the surface density of the magnesium oxide crystals included in the electron emissive layer in the intersection regions is equal to or lower than half the surface density of the magnesium oxide crystals included in the electron emissive layer in a whole or part of the remaining region.

16. The plasma display panel according to claim 15, wherein the part of the remaining region is a strip-shaped region extending, along the second direction, between the projecting part of the first transparent electrode included in one of the sustain electrodes and the projecting part of the second transparent electrode included in one of the scan electrodes and having a same width as the discharge gap.

17. The plasma display panel according to claim 15, wherein the part of the remaining region is a rectangular region extending, along the second direction, between the projecting part of the first transparent electrode included in one of the sustain electrodes and the projecting part of the second transparent electrode included in one of the scan electrodes, having a same width as the discharge gap, and being directly above one of the address electrodes.

18. The plasma display panel according to claim 15,
wherein the discharge cells are partitioned by a plurality of longitudinal ribs extending along the first direction and a plurality of transverse ribs extending along the second direction; and
wherein the part of the remaining region is a strip-shaped region extending peripherally to one of the longitudinal ribs and not being directly above any of the address electrodes.

19. The plasma display panel according to claim 15,
wherein the discharge cells are partitioned by a plurality of longitudinal ribs extending along the first direction and a plurality of transverse ribs extending along the second direction; and
wherein the part of the remaining region is a rectangular first region extending peripherally to one of the longitudinal ribs along the first direction, the rectangular first region overlapping, as seen in a front view of the discharge cells, with one of the sustain electrodes, one of the scan electrodes, and space between the one of the sustain electrodes and the one of the scan electrodes, not being directly above any of the longitudinal ribs and any of the address electrodes, and overlapping with neither of the projecting part of any of the sustain electrodes and the projecting part of any of the scan electrodes.

20. The plasma display panel according to claim 15,
wherein the sustain electrodes each include a first transparent electrode having a first width and a first bus electrode formed on a back side of the first transparent electrode and having a second width smaller than the first width and the scan electrodes each include a second transparent electrode having a third width and a second bus electrode formed on a back side of the second transparent electrode and having a fourth width smaller than the third width; and
wherein the part of the remaining region is a strip-shaped region including one of the first bus electrodes or one of the second bus electrodes and a gap formed, adjacently to the one of the first bus electrodes or the one of the second bus electrodes, to extend along the second direction between adjacent two of the discharge cells adjacent along the first direction.

21. The plasma display panel according to claim 15,
wherein the sustain electrodes each include a first transparent electrode having a first width and a first bus electrode formed on a back side of the first transparent electrode and having a second width smaller than the first width and the scan electrodes each include a second transparent electrode having a third width and a second bus electrode formed on a back side of the second transparent electrode and having a fourth width smaller than the third width; and
wherein the part of the remaining region is a rectangular region including one of the first bus electrodes or one of the second bus electrodes and a gap formed, adjacently to the one of the first bus electrodes or the one of the second bus electrodes, to extend along the second direction between adjacent two of the discharge cells adjacent along the first direction and being directly above one of the address electrodes.
